(19) United States
(12) Patent Application Publication
(10) Pub. No.: US 2006/0190182 A1
(43) Pub. Date: Aug. 24, 2006

(54) Method of calculating seismic bracing

(75) Inventor: Joseph L. LaBrie, Arcadia, CA (US)

Correspondence Address: HOFFMAN & BARON, LLP, 6900 JERICHO TURNPIKE, SYOSSET, NY, 11791, US

(73) Assignee: Thomas & Betts International, Inc.

(21) Appl. No.: 11/261,693

(22) Filed: Oct. 28, 2005

Related U.S. Application Data
(60) Provisional application No. 60/650,434, filed on Feb. 4, 2005.

(51) Int. Cl. G01V 1/28

(52) U.S. Cl. 702/18

(57) ABSTRACT

This invention pertains to a novel method of calculating seismic bracing and more particularly to a method of selecting and positioning support components for a bracing system without calculating the forces in these components comprising, choosing a design configuration of the bracing system, determining the seismic coefficient of the design configuration, ascertaining a load rating for the design configuration, consulting one or more pre-engineered tables to select the support components, the spacing of the support components, and the anchor details and configuration of the support components.

### CROSS-REFERENCE TO RELATED APPLICATION

This application claims priority to U.S. Provisional Application No. 60/650,434, filed Feb. 4, 2005, which is incorporated herein by reference.

### FIELD OF THE INVENTION

The present invention relates to a method of selecting structural components required to resist seismic forces and more particularly to a method directed to ascertaining such components for use when supporting pipe or other mechanical components such as duct work for example from an overhead structure.

### BACKGROUND OF THE INVENTION

It is quite common when designing the support members of a structure to first calculate the overall loading on the structure and then work down from this overall loading to the forces on the individual support members comprising the structure. Often times the procedure to initially determine this overall loading on the structure is by taking into account all safety factors and other forces that the structure must resist. Afterwards, an appropriate support member that can resist the calculated force is ascertained from a table or chart for subsequent inclusion in the construction of the desired structure. Anchoring detail is also necessary to secure the individual support members together or to some other support.

In the case of a pipe support, the overall configuration of each individual supporting structure along the length of the pipe must first be conceived (top support, bottom support, side support, single hanger, dual hanger, etc.). Then, the spacing of these individual structures along the pipe must be estimated in order to find the load that each such structure is to resist. Once the individual structural loads are calculated, the size and bracing of the hanger elements must be computed. In the case of ceiling supported structures, the size of the hanger rod is to be computed and whether such rod or rods need to be braced must be ascertained. Presuming bracing is required under the anticipated seismic or other loading or to comply with code requirements, the individual bracing loading must be calculated. Also, the manner of attachment of the brace and the rod to the structure itself and to each other must be considered.

Once all these various components, materials and methods of attachment are selected, the assembly as a whole must be investigated to insure that it will withstand the desired loading and that it meets code. If not, then the process starts all over again with the selection of another of the eligible support members or another manner of attachment or another size brace or another brace spacing or another rod size, etc.

Each time and for each such selection, the characteristics of the various component parts of the assembly will need to be re-calculated, their characteristics re-compiled and their combination re-computed.

A key drawback of this iterative and circular method of calculation is that it is quite time consuming and may result in components that are over-designed for their intended purpose. For example, a beefier initial member might be selected when one that is more compact but with more bracing or closer spacing might do just as well and cost considerably less. Hence, a result of following the above method is the general acceptance of the first assembly whose calculations satisfy all the requirements, not necessarily the assembly that meets all structural requirements, and is least costly to produce or the easiest to install.

For these reasons, it is desirable to provide a method of selecting structural members for supporting mechanical components such as piping and duct work in an efficient method and one that does not require more than one iterative step to arrive at the optimum solution with respect to structural, cost and installation considerations.

### SUMMARY OF THE INVENTION

The present invention provides a method of design and selection of a bracing system to support mechanical components in a building in a single iterative step to arrive at the optimum solution with respect to structural, cost and installation considerations.

The present invention solves the problems of the prior art systems by providing a method for designing a bracing and support system and selecting the required components in a linear workflow method that accounts for all design considerations during the workflow, allows for the selection of the proper components and component assemblies and verifies that the requirements are satisfied in an efficient manner.

It is therefore an object of this invention to provide a different method of using loading to calculate the required structural members to support a particular load. Another object of this invention is to eliminate the ‘circular’ method employed in the past such that in a single iterative step the method according to the present invention will result in the assembly of components that most efficiently satisfies structural, cost and installation considerations. In accordance with the method of the present invention, no re-calculations or re-designs are necessary, the best solution is determined in a single step.

Still another object of this method is to devise a system of selecting structural members from a series of tables that are organized in such a way that additional or further calculations based on these various members are eliminated. Another object of this invention is to pre-arrange the various components within these tables by such factors as seismic factor and load characteristic.

In the efficient attainment of these and other objectives, the present invention provides a method of selecting and positioning support components for a bracing system without calculating the forces in these components comprising, choosing a design configuration of the bracing system, determining the seismic coefficient of the design configuration, ascertaining a load rating for the design configuration, consulting one or more pre-engineered tables to select the support components, the spacing of the support components, and the anchor details and configuration of the support components.

### BRIEF DESCRIPTION OF THE DRAWINGS

FIG. 1 is a design procedure flow chart showing the assembly design method in accordance with the current invention.

FIG. 2 discloses an exemplary graph of the value of z/h on the vertical axis and the seismic factor on the horizontal axis for use in accordance with the method of the current invention.

FIG. 3 shows an exemplary design table having a seismic factor of 0.25 for use when designing a single hanger pipe assembly to be secured to an overhead concrete support.

FIG. 4 shows an exemplary design table having a seismic factor of 0.75 for use when designing a single hanger pipe assembly to be secured to an overhead steel support.

FIG. 5 shows an exemplary design table having a seismic factor of 1.0 for use when designing a dual hanger or trapeze pipe assembly to be secured to an overhead wood beam supporting a medium load.

FIG. 6 illustrates an exemplary load category table.

FIG. 7 is an exemplary pipe anchorage selection table for concrete when employing a single hanger pipe assembly.

FIG. 8 discloses an exemplary trapeze anchorage selection table for wood.

FIG. 9 discloses exemplary anchoring details for the anchorage selection of FIG. 7.

FIG. 10 discloses exemplary final assembly details for the anchorage selection of FIG. 7.

FIG. 11 discloses exemplary longitudinal bracing details for the anchorage selection of FIG. 10.

FIG. 12 an exemplary design table having a seismic factor of 1.5 for use when designing a dual hanger or trapeze pipe assembly to be secured to an overhead wood beam supporting a heavy load.

FIG. 13 discloses exemplary trapeze support details for the anchorage selection table set forth in FIG. 8.

FIG. 14 discloses exemplary trapeze support details for the anchorage selection table set forth in FIG. 8 illustrating the use of double channels.

FIG. 15 discloses exemplary wood anchor details for the anchorage selection table set forth in FIG. 8.

### DETAILED DESCRIPTION OF THE PREFERRED EMBODIMENT

The following is a detailed description of the preferred embodiments of the present invention. The description is meant to describe the preferred embodiments, and is not meant to limit the invention in any way.

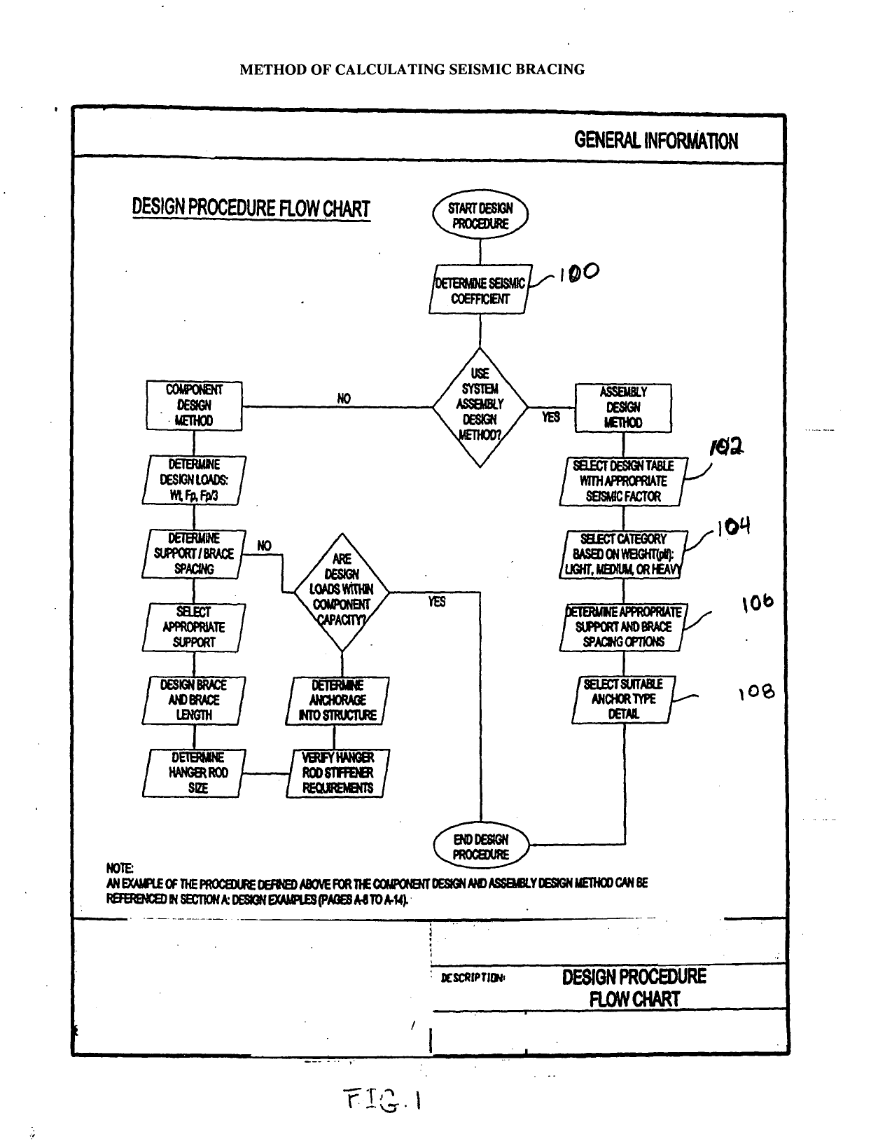

FIG. 1 shows a flow chart depicting the assembly design method in accordance with the present invention. The work flow depicted is a process that addresses the demand and capacities of a pre-designed assembly of specific components and anchorages. The method makes use of load groups and categorizes associated assembly and anchorages details within categories of “light”, “medium” and “heavy”. Furthermore, the method accounts and provides for anchorage into structures of concrete, steel or wood. Therefore, the user is able to select the appropriate anchorage for the project in question to provide the optimum solution for the bracing support structure in question.

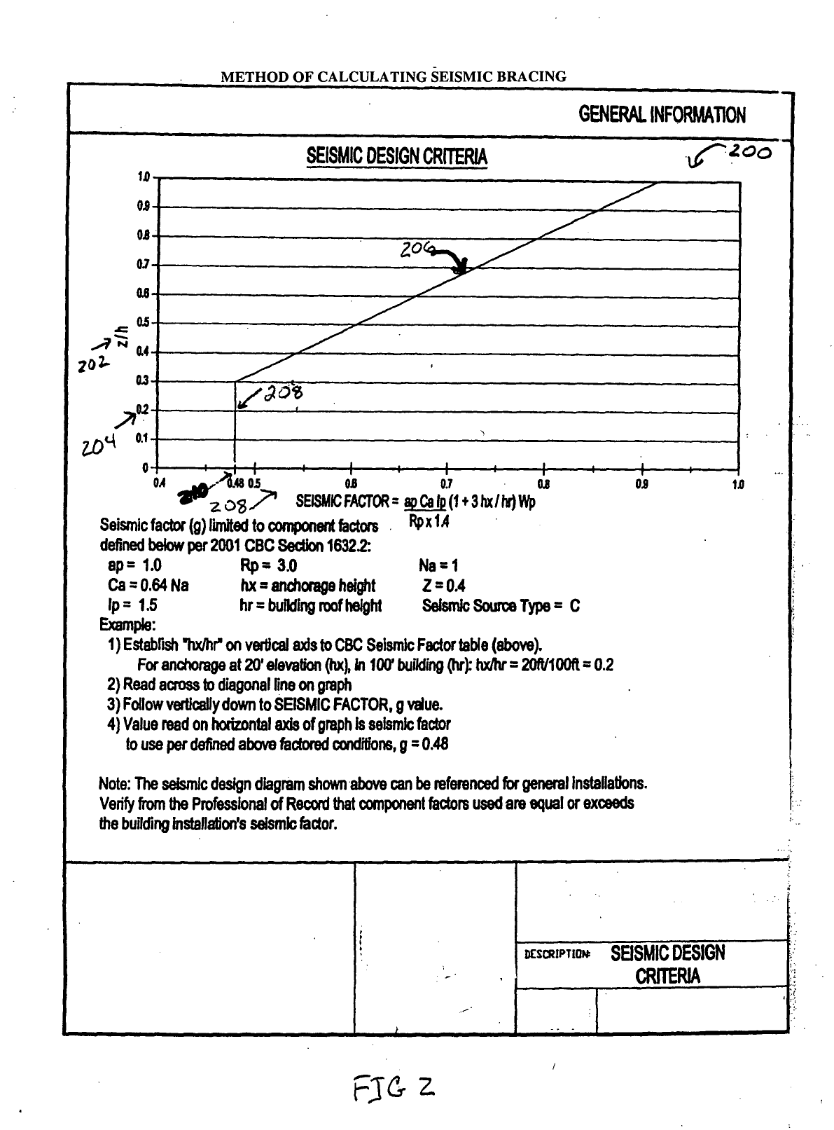

In the work flow diagrams depicted, prior to beginning the new assembly design method in accordance with the present invention the user must first select or determine the seismic coefficient or seismic factor 100 for the structure to be assembled based on the loading that this structure is to incur. Determining the seismic coefficient or factor 100 in one embodiment can be accomplished in accordance with the graph 200 depicted in FIG. 2 indicated therein using the values provided. This graph 200 shown in FIG. 2 is based on seismic force design criteria as defined in the 2001 California Building Code (CBC) incorporated herein. The necessary coefficients should be acquired from the Professional of Record and applied to the seismic design requirement in Section 1632.2 of the 2001 CBC.

The graph of FIG. 2 is utilized by first establishing “hx/hr”, or “z/h” on the vertical axis 202 of the graph 200 where hx=anchorage height and hr=building height. For example for anchorage at 20 feet elevation (hx) in a 100 foot building (hr): hx/hr=20/100=0.2. Once the value of “hx/hr” is determined, in this example 0.2, the user finds the point corresponding to that value on the vertical axis 202 of graph 200. In this example, at point 204, the user then reads horizontally across the graph to the point of intersection with line 206, which in accordance with the stated exemplary value of 0.2 occurs at point 208. The seismic factor (g) is then determined by determining the value on the horizontal axis of graph 200 that corresponds to point 208. In this example point 210, which has a value of 0.48. When employing this seismic factor in accordance with the invention, it is always rounded up.

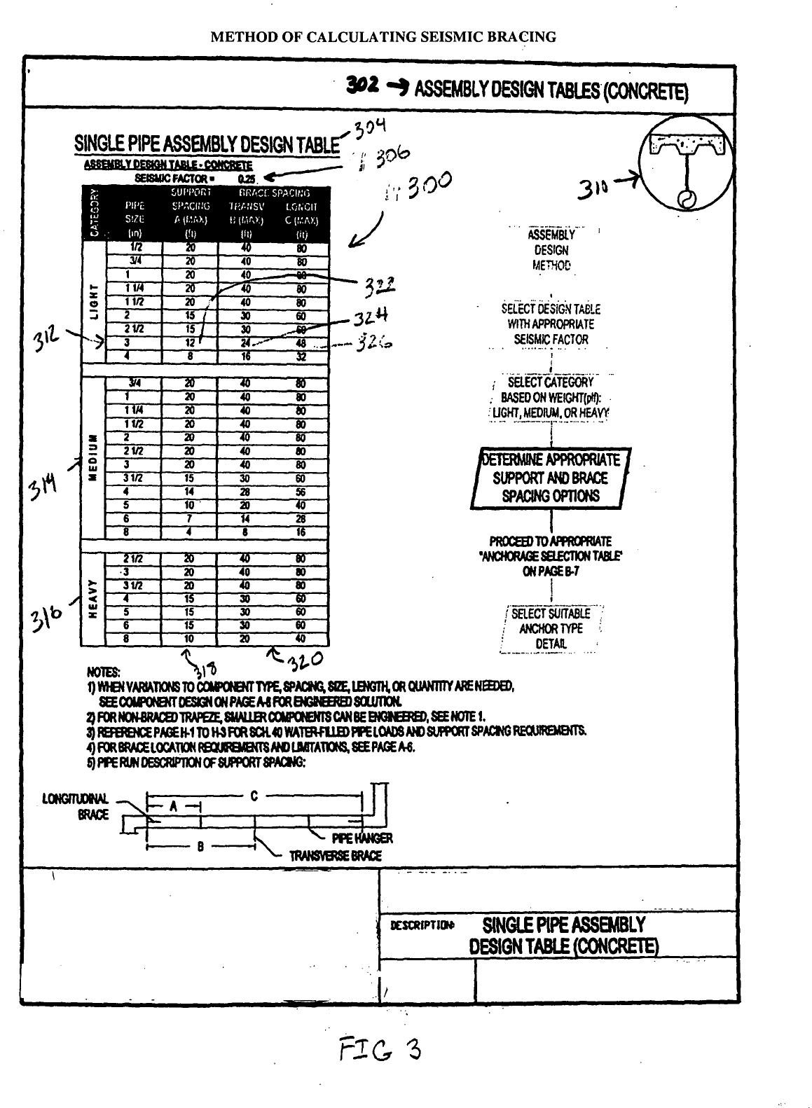

Referring back to FIG. 1, once the seismic coefficient or factor (g) is determined in step 100, the user proceeds to step 102 when using the system assembly design method of this invention. Step 102 includes selecting the design table having the appropriate seismic factor. Turning to FIG. 3, there is shown an exemplary depiction of an assembly design table for use in accordance with step 102 when using the system assembly design method of this invention. In accordance with the exemplary seismic coefficient determined in step 100, the user must select the appropriate design table. The design tables are produced to account for the differences in anchorage, i.e. wood, concrete or steel, and the type of hanger to be used. Specifically single or dual hanger, also known as a trapeze support. Therefore, the user must select the assembly design table for the anchorage and hanger in use for the calculated seismic coefficient. In the exemplary assembly design table 300 of FIG. 3, there is a designation heading 302, indicating that the exemplary table is intended for use with concrete anchorages. Furthermore, the table heading 304 indicates that the table is to be used in the design of a single hanger or single pipe assembly. Furthermore, the seismic factor 306 is indicated. Therefore, the design table 300, depicted in FIG. 3 is the appropriate table for when the seismic factor or coefficient 306 is 0.25 or less; when the support structure is to be a single pipe assembly; and, when concrete is the final supporting material. Note also the symbol 310 in the upper right hand corner of FIG. 3 designating its use for a single hanger from concrete structure. Additional design tables would be provided to the user for different seismic factors as well as for wood and steel anchorage. Design table 300, also includes sections for “Light” 312, “Medium” 314 and “Heavy” 316 loading.

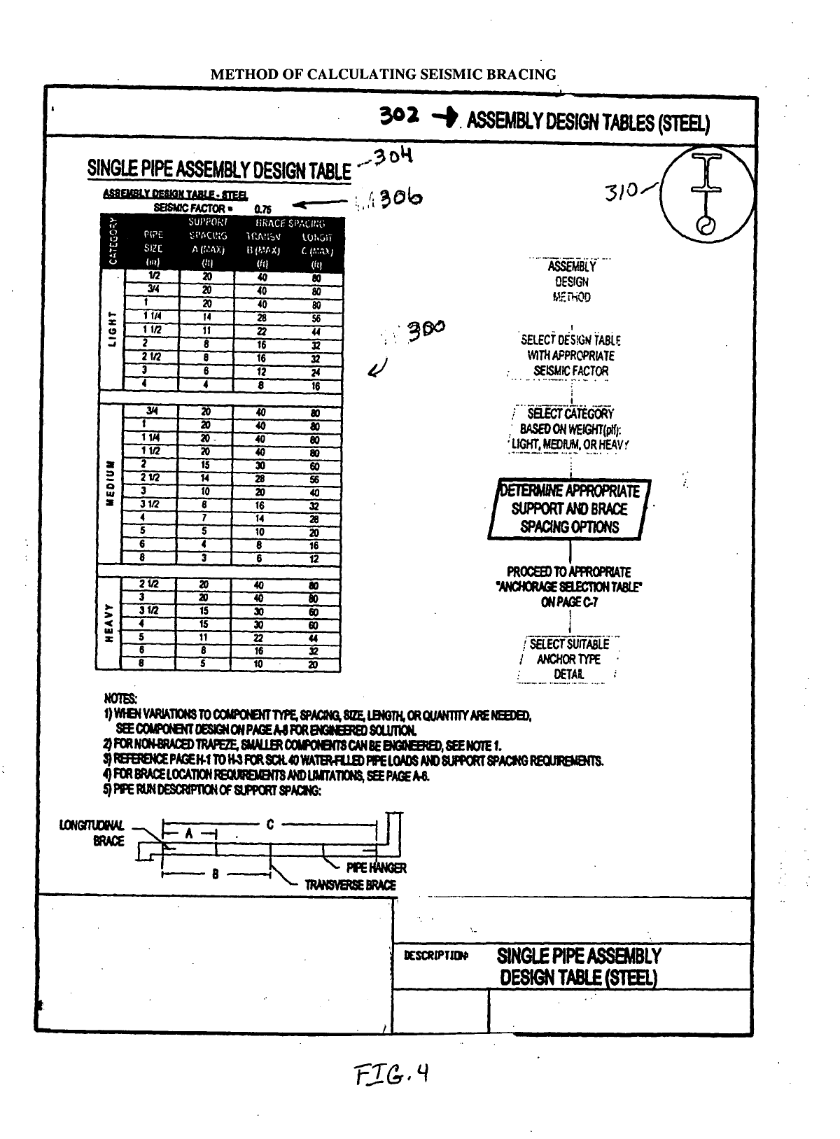

As can be seen, different design tables 300 are employed depending on the seismic factor, the type of support assembly and the material to which the assembly will be affixed. Each such design table 300 is itself specially calculated to provide information such as pipe size, support spacing and brace spacing. Thus, each design table 300, has been pre-engineered or pre-determined so that the proper structural members can be selected without the user having to manually perform these calculations for each hanging system to be designed as would be the case when applying the component design method. By way of further example, another design table 300 is shown in FIG. 4. This design table 300 is to be employed when the seismic factor 306 is 0.75 or less; when the support structure is to be a single pipe assembly; 304 and, when the material supporting the assembly is steel 302. Note also the single pipe hanger or assembly symbol 310 in the upper right hand corner of FIG. 4.

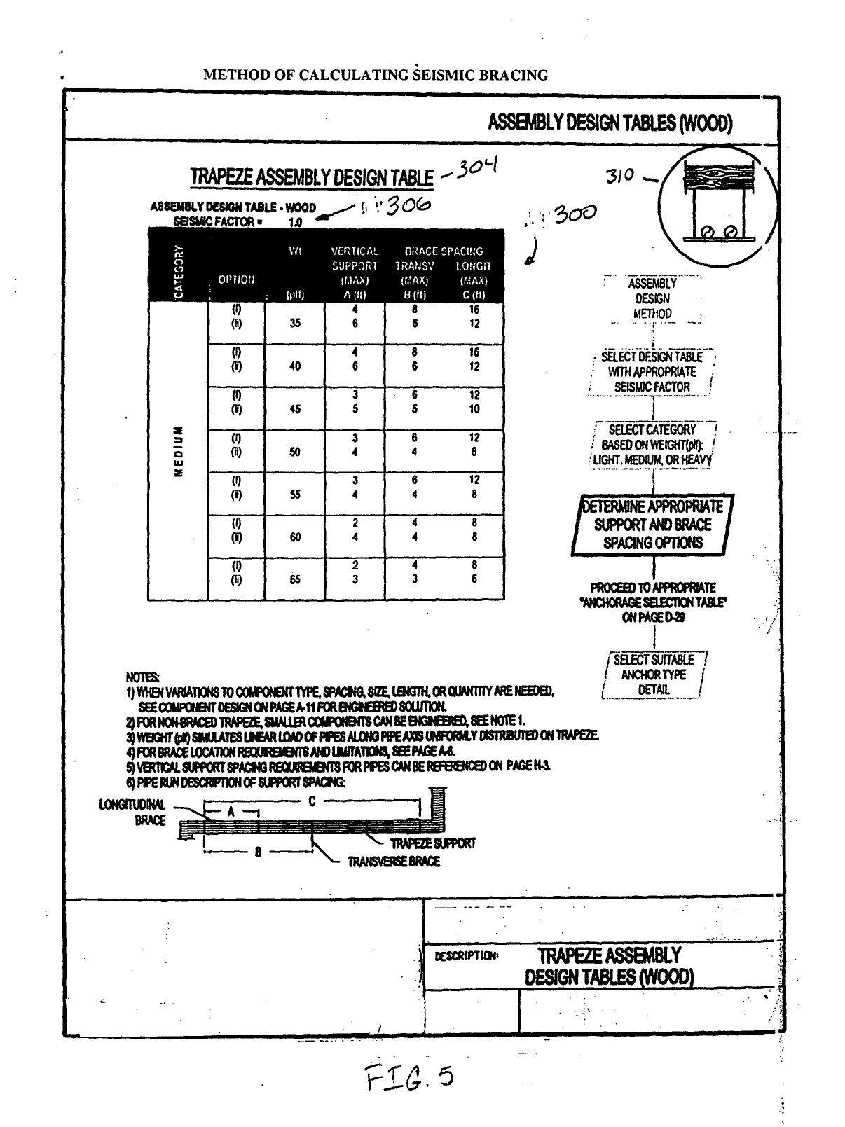

Yet another exemplary design table 300 is shown in FIG. 5. This design table 300 is to be employed when the seismic factor 306 is 1.0 or less; when the support structure is to be of the trapeze type 304; and, when the assembly is affixed to wood 302. Note also the tandem pipe hanger or assembly symbol 310 in the upper right hand corner of FIG. 5. It should further be understood by one skilled in the art that in accordance with the present inventive method, the user will be presented with the appropriate assembly design tables to cover all permutations of design criteria.

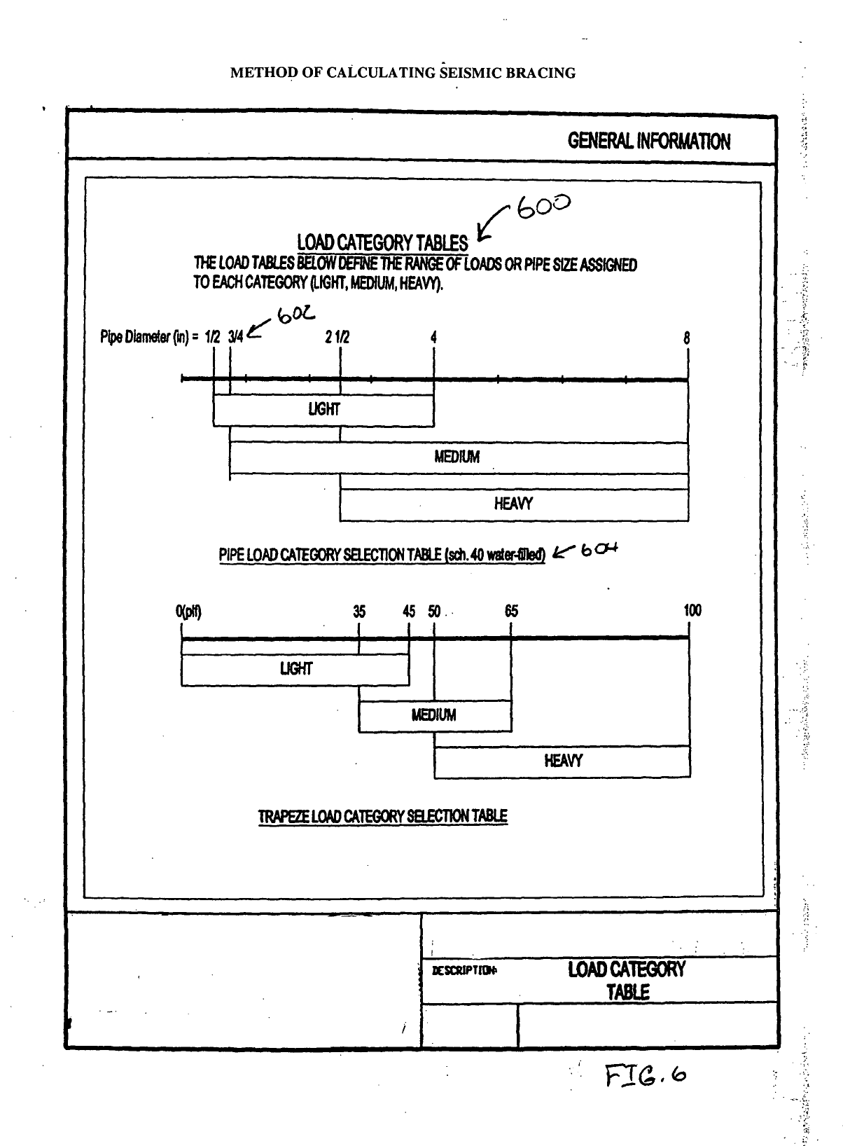

Once the user has selected the appropriate assembly design table in step 102, the user moves on to the next design step in accordance with the current invention. Turning again to FIG. 1, the following step 104 includes selecting the appropriate category based on weight, that being “Light”, “Medium” or “Heavy”. This selection will direct the user to the appropriate section of design table 300, that being 312, 314, 316 respectively. In order to select a weight category: light, medium or heavy, the user makes reference to FIG. 6. Load category tables 600 shown in detail in FIG. 6 assist the user in making this selection by establishing some criteria, based on either pipe diameter 602 or load per linear foot (plf) 604, upon which to make this selection. Obviously, a smaller pipe or a pipe that presents less loading characteristics will be in the ‘light’ category while larger or heavier pipes will be in the ‘heavy’ category. Those in-between will be deemed to be in the ‘medium’ category. There is considerable overlap between the various categories as seen in load tables 600.

Referring once again to FIG. 1, the next step in the method according to the present invention is to determine the appropriate support and bracing options 106. Once the user has ascertained the load characteristic (i.e. light, medium or heavy) and has already determined seismic factor 306, the material supporting the assembly (concrete, steel or wood) as well as whether the support is to comprise a single or a multiple hanger design, the user is ready to determine the appropriate support and brace spacing options 106. By consulting the appropriate design table 300 such as that shown in FIG. 3, the user determines the support spacing 318 and brace spacing 320, by selecting the horizontal row corresponding to the pipe size to be installed under the appropriate load characteristics. In the example of a 3 inch pipe subject to a “light” loading, the proper support spacing is given as 12 feet 322 with a brace spacing of 24 feet transverse 324 and 48 feet longitudinal 326.

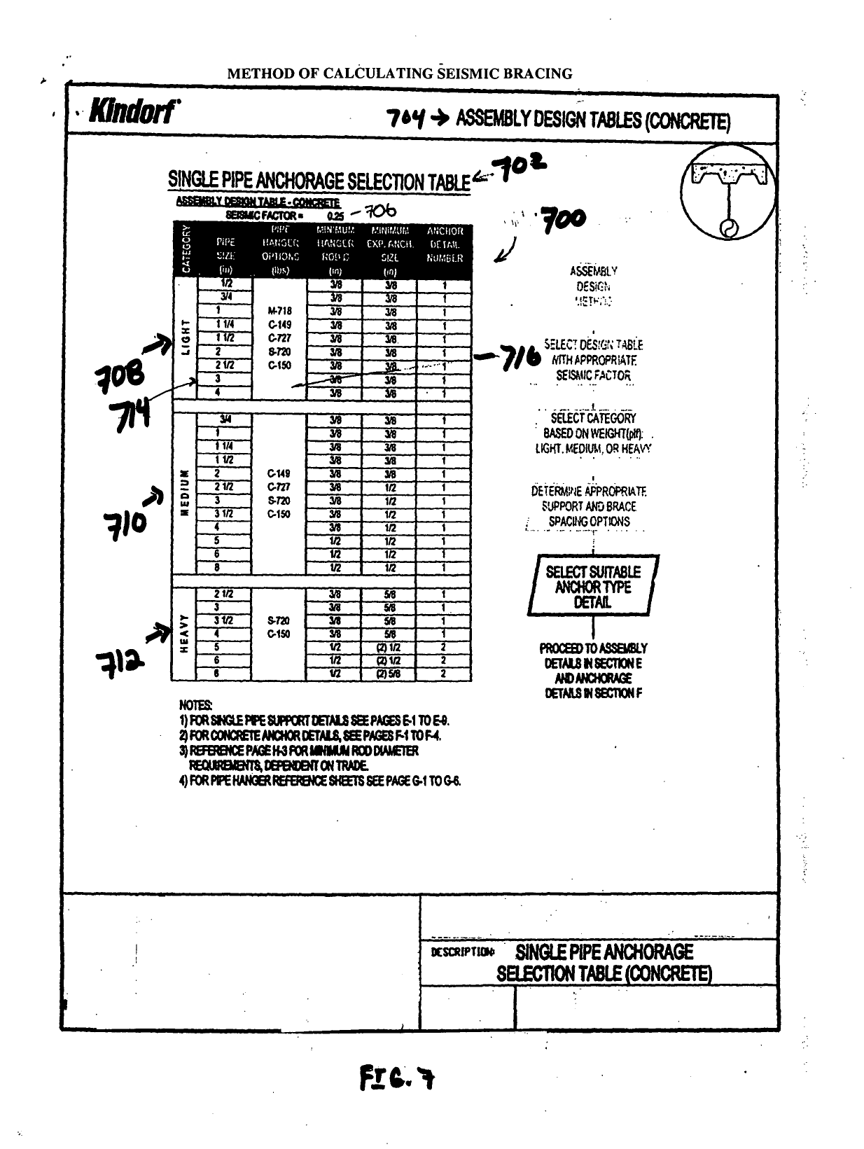

The final step in accordance with the method of the current invention is set forth in FIG. 1; Select Suitable Anchor Type Detail 108. Turning to FIG. 7, step 108 can be fully explained.

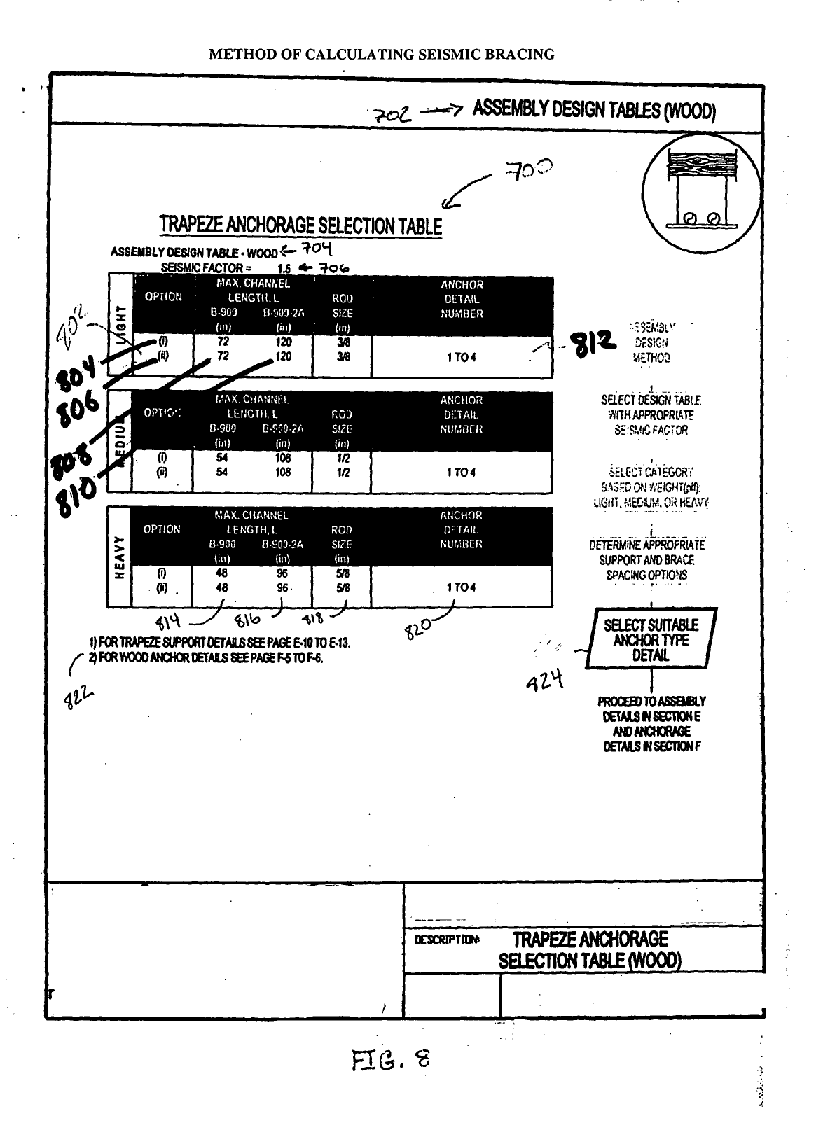

FIG. 7 includes a Single Pipe Anchorage Selection Table 700. Similar to table 300 previously detailed, table 700 is indicated for use with concrete anchorage 702 and 704 and for a seismic factor of 0.25 706 corresponding with that shown in FIG. 3. As with table 300 of FIG. 3, the user will be provided with a selection of anchorage selection tables 700 to cover the various permutations of design choices, that being; concrete, wood or steel anchorage, single pipe or multiple pipe (trapeze) hangers and a range of seismic values. By way of example, FIG. 8 presents an anchorage selection table 700 for a wood anchorage 702 and 704 for a seismic factor of 1.5 706. It should further be understood by one skilled in the art that in accordance with the present invention method, the user will be presented with the appropriate tables to cover all permutations of design criteria. Different anchorage selection tables 700 are employed to account for the different design criteria present.

Turning again to FIG. 7, anchorage selection table 700 includes specifications for “light” 708, medium 710 and “heavy” 712 pipe sizes. Utilizing the same light-duty, 3″ pipe example as above, the user will find that any of five different pipe hanger options are suitable for use, as listed in field 716 pipe hanger option. Also, the user is informed that ⅜ inch diameter hanger rod and ⅜ inch diameter expansion anchors can be employed as shown in Anchor Detail Number 1 which will be described in greater detail below. For further purposes of explanation, presume the user selects pipe hanger option M-718 as listed in field 716 of FIG. 7. A note in this FIG. 7 informs the user to proceed to one section, Section E for pipe hanger details and to proceed to another section, Section F for anchorage details.

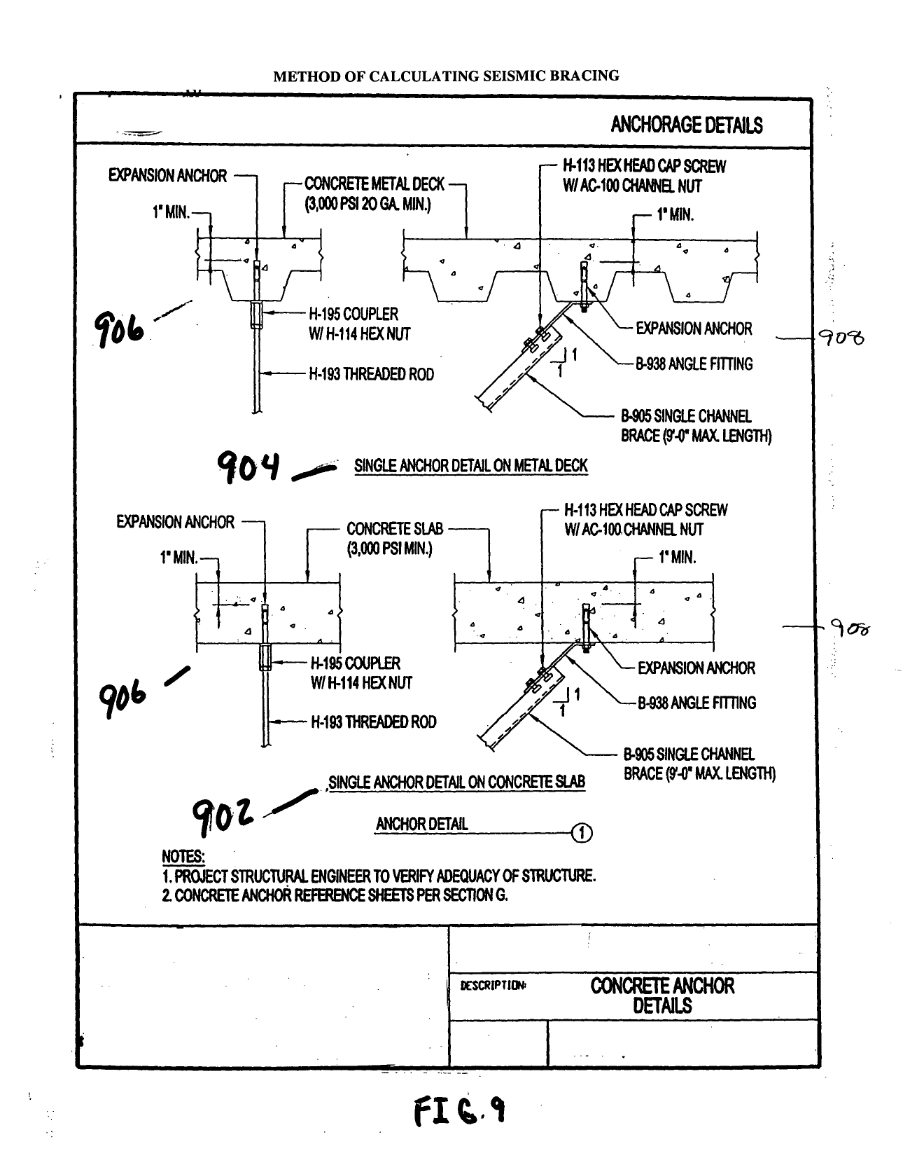

Referring to anchorage details first, in FIG. 9, difference is made whether the anchor is to be in a generally uniform concrete slab (lower details) 902 or in a concrete metal deck (upper details) 904. The anchor details for the hanger rod are shown to the left 906 while the anchor details for the brace are shown to the right 908. Whichever concrete flooring is used, the necessary anchoring details for this assembly is provided to safely secure a lightly loaded 3″ pipe in place against seismic loads.

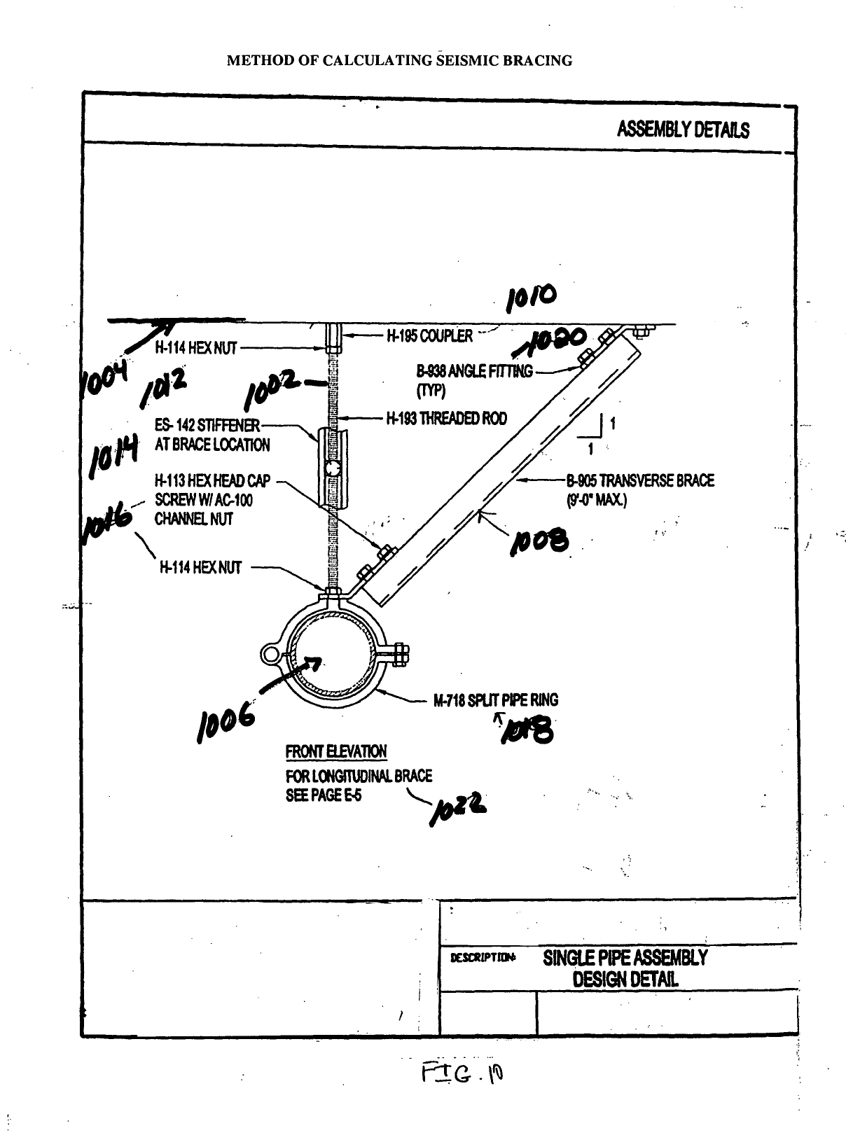

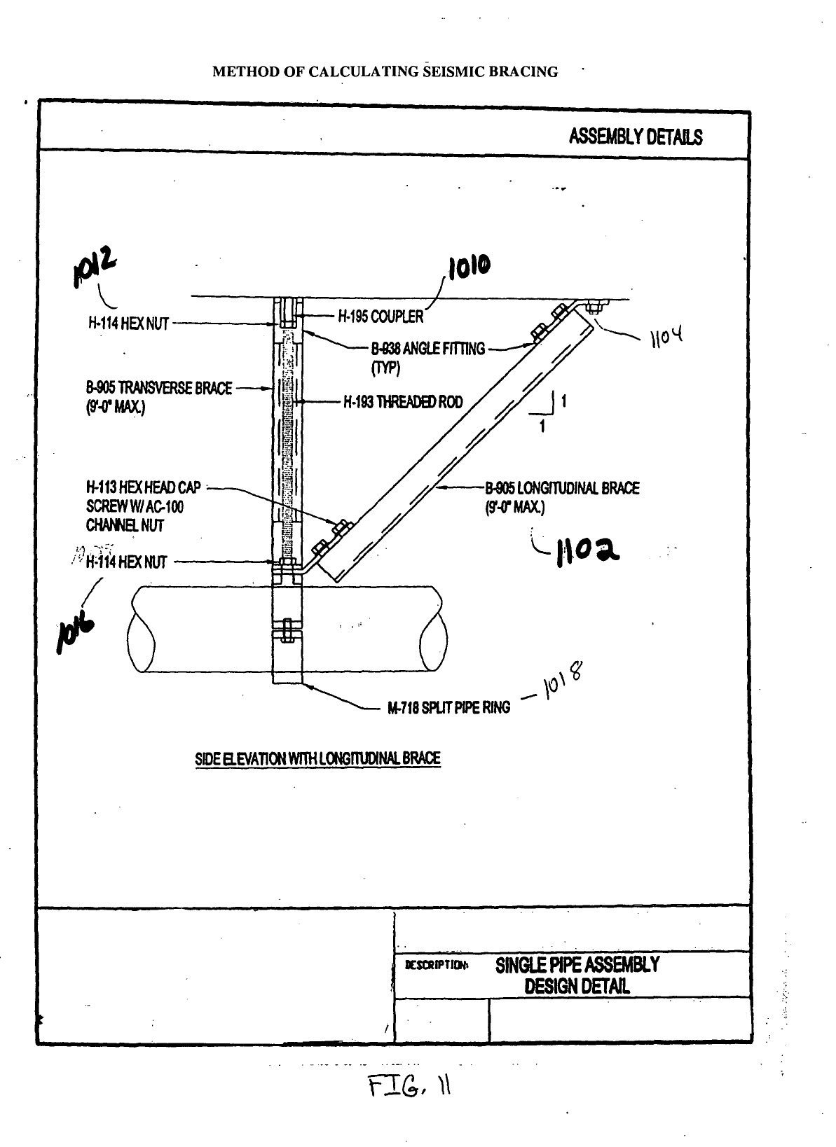

Referring now to pipe hanger assembly option M-718, previously selected and as shown in FIG. 10. Here, the ⅜″ diameter hanger rod 1002, as previously selected with reference to Anchorage Selection Table 700 shown in FIG. 7, is suspended from the concrete support 1004 along the run of the pipe 1006 with transverse bracing 1008 every 24 feet 324, which the user finds in accordance with the brace spacing requirement previously given in table 300 of FIG. 3. Details on the various hardware necessary to complete this support assembly are also provided in this FIG. 10 for pipe hanger assembly option M-718, including the coupler 1010, and associated hex nut 1012. The rod stiffener 1014, hex nuts 1016 for attaching the split pipe ring 1018 to the transverse brace 1008 and angle fitting 1020 for attaching transverse brace 1008 to concrete support 1004 are also identified. There is also a note referencing the longitudinal bracing 1022 that is required at least every 48 feet, as previously determined with reference to FIG. 3, in this example. Details on such longitudinal bracing can be found in FIG. 11 which provides hardware and assembly information regarding selected option M-718, such that such longitudinal bracing can be installed as needed.

Turning to FIG. 11, there is shown a longitudinal bracing assembly detail for pipe hanger option M-718. Similarly to the transverse brace of FIG. 10, there is shown a detail on the various hardware necessary to complete this longitudinal support assembly, including the coupler 1010, and associated hex nut 1012. Details on hex nuts 1016 for attaching the split pipe ring 1018 to the longitudinal brace 1102 and angle fitting 1104 for attaching longitudinal brace 1102 to concrete support 1004 are also provided.

For purposes of complete understanding, another example will be presented; this time pertaining to a trapeze support suspended from wood. Such trapeze support a would be employed when supporting two or more runs of a longitudinal member (although a trapeze design can also be used to support a single run of a longitudinal member if so desired). The example shown supposes the longitudinal member being a pipe, but it could just as easily be duct or tray or any other device requiring spaced supports.

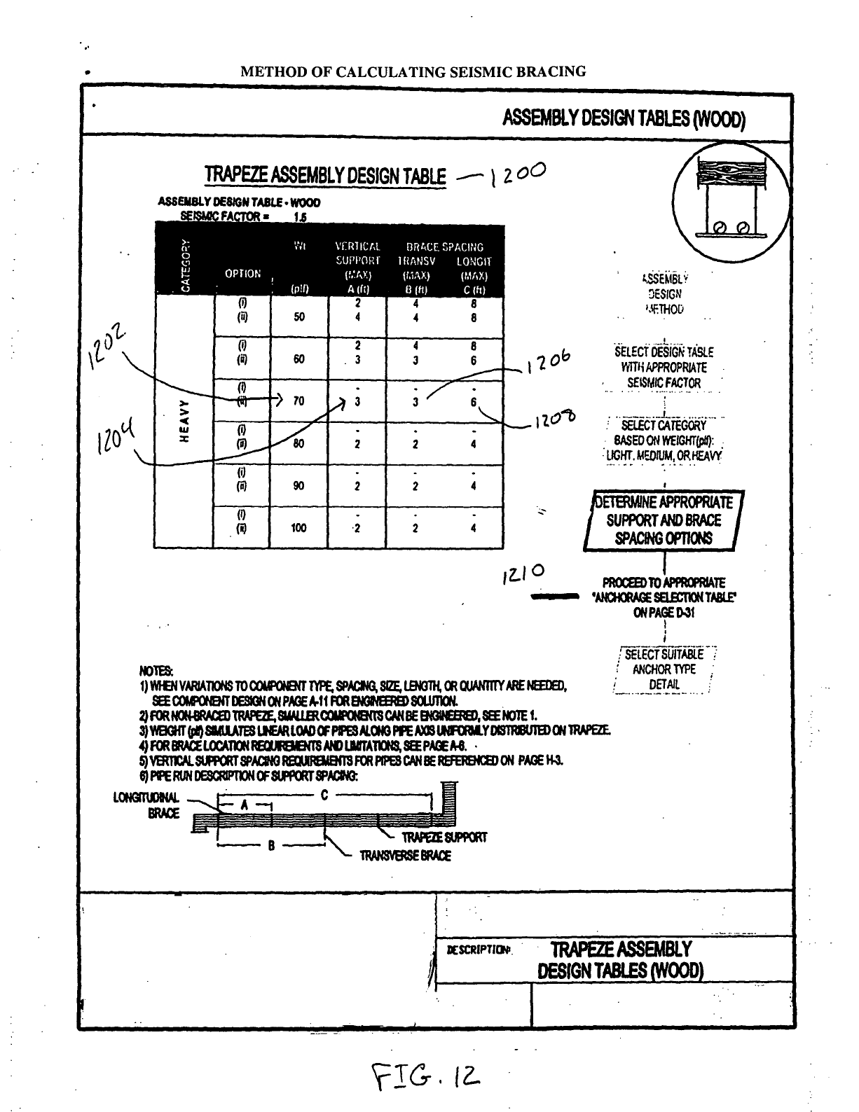

The example that follows will pertain to the support of heavy piping having a loading of 70 pounds per linear foot and employing a seismic factor of 1.5. It should be noted that the above information is rather basic in nature and does not require much in the manner of calculation by the user. Thus in this example the user will proceed to step 106 of FIG. 1 to determine appropriate support and brace spacing option. From this initial criteria the user will consult the proper assembly design table as described above. Turning to FIG. 12, there is show trapeze assembly design table 1200 satisfying the above criteria. For weight 70 plf 1202, it will be seen that there is only one option (option ii) available, the vertical support 1204 is to be spaced 3 feet maximum; transverse bracing 1206 is to occur every 3 feet 1208; and longitudinal bracing 1208 is to occur every 6 feet.

Given the above design parameters, the user will consult the appropriate assembly design table. In this case the anchorage details for this assembly are provided on FIG. 8 as shown by reference 1210 on FIG. 12. Turing now to FIG. 8 and recalling that this example is limited to option (ii) for heavy loading, the resultant maximum channel lengths for single B-900 channel is 48 inches 814 whereas the maximum channel length for double B-900-2A channel is 96 inches 816, each supported by ⅝ inch rod 818 and eligible for anchor details 1-4820 as selected. The notes following the tables 822 on FIG. 8 indicate where to find trapeze support details and wood anchor details under the given design conditions.

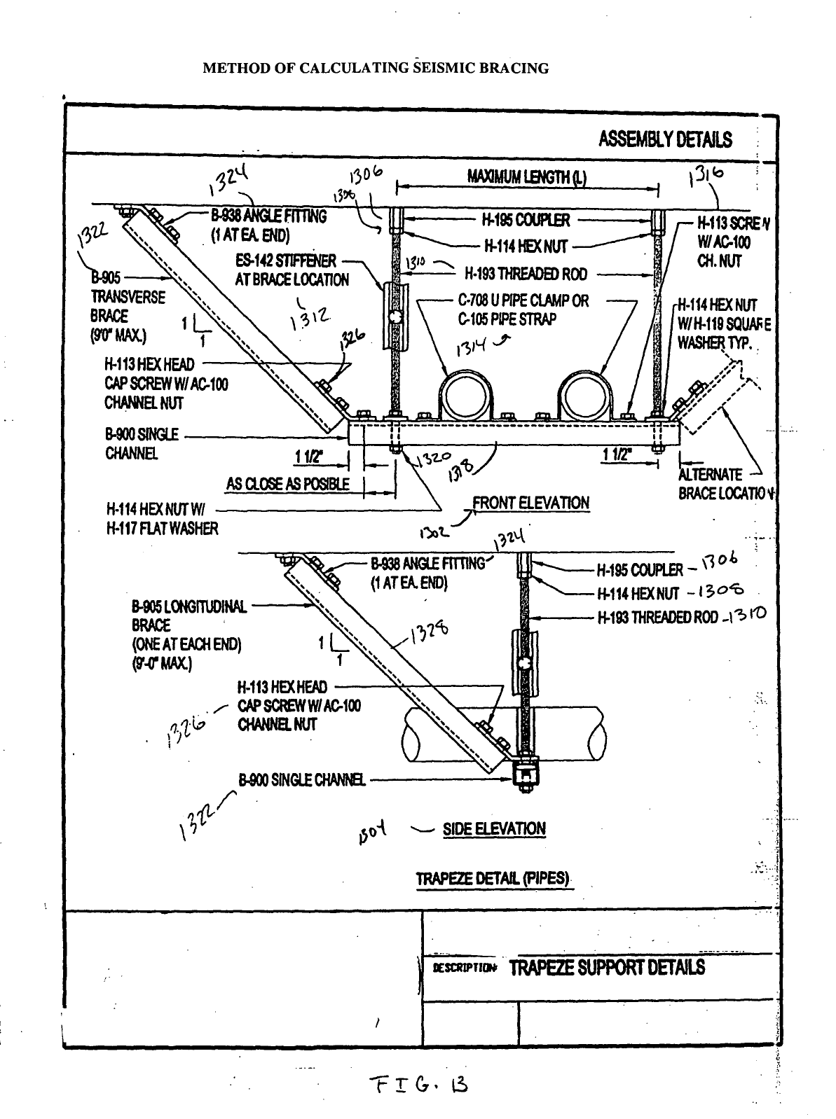

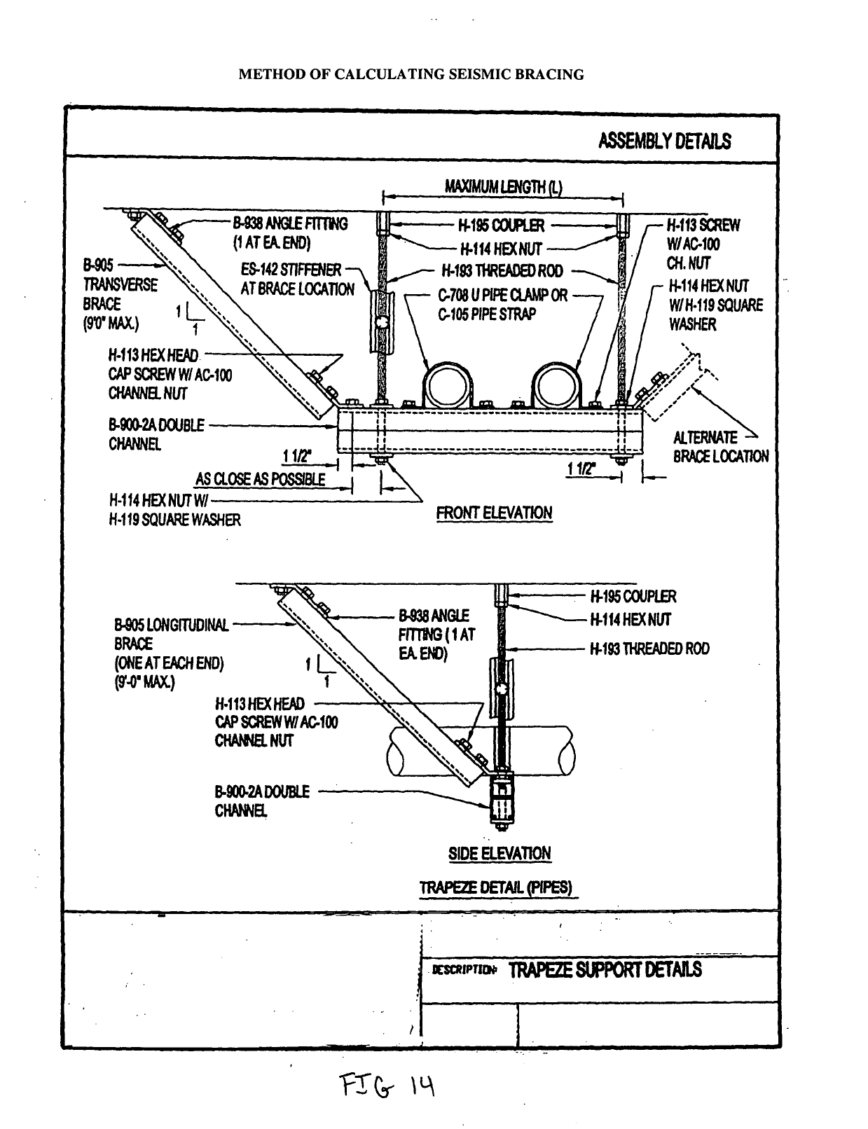

Turning now to FIG. 13 which shows the trapeze support details identified in the notes of FIG. 8 for single channel length, B-900. It should be noted that depending on the type of trapeze desired the user is provided with assembly details for all of the trapeze support variations possible. For example, if single B-900 channel 814 is selected then the maximum length between ⅝ inch hanger rod is the above specified 48 inches. However, if double channel B-900-2A 816 is selected then the maximum length between ⅝ inch hanger rod is the above specified 96 inches and the assembly details for such channel are also shown in FIG. 14.

Turning again to FIG. 13, there is shown the assembly details for the selected trapeze support in accordance with the given design parameters. As described with respect to the previous example, the assembly details include and provide specifications for all component parts of the trapeze hanger. The assembly details are divided into a front elevation view 1302 and a side elevation view 1304. The front elevation 1302 includes specifications for the coupler 1306 and associated hex nut 1308, threaded rod 1310, stiffener 1312, U pipe clamp or pipe strap 1314, and associated screw 1316 and nut. The screw 1316 and nut attach U pipe clamp 1314 to the single channel support 1318. In addition, the hex nut and washer 1320 for attaching the rod 1310 to single channel support 1318 are also indicated. Finally, transverse brace 1322 and attachment hardware, angle fitting 1324 and hex head cap screw and channel nut 1326 are noted for the users reference. The side elevation view 1304 further include the reference for the appropriate longitudinal brace 1328.

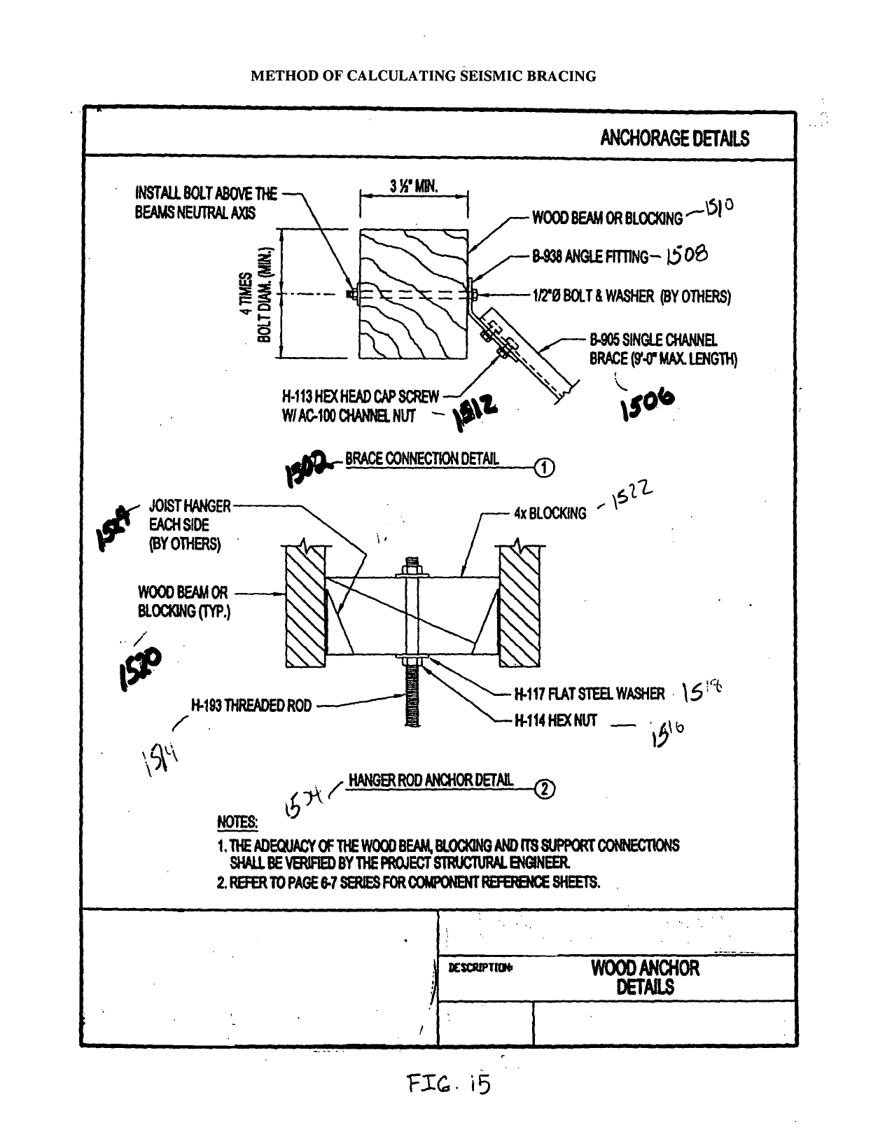

Turning again to FIG. 8, note 822 further specifies the wood anchor details. Therefore, once the user has selected the appropriate components for the trapeze support details in accordance with the specification contained in FIG. 13, the user is directed to select the suitable anchor type detail 824. In order to complete this step, the user is directed to the appropriate anchor detail selection sheet. An exemplary version of which is reproduced as FIG. 15. FIG. 15 depicts a brace connection detail 1502 and a hanger rod anchor detail 1504. The brace connection detail 1502 includes the specification for the single channel brace 1506, angle fitting 1508 for attachment to the wood beam 1510 and the hex head cap screw and channel nut 1512. Likewise the hanger rod anchor detail includes the specifications for the threaded rod 1514 and hex nut 1516 and washer 1518. The specification includes reference to the surrounding structure, such as the wood beam 1520, blocking 1522 and joist hangers 1524 which are not part of the hanger system, but are provided as a reference to the user with respect to anchor placement and attachment points.

Obviously, and as evidenced above, the present assembly design method is quite capable and quite rapid at supplying the necessary assembly details and mounting hardware needed to construct these hanger supports. Very little, if any, manual calculations by the user are required unlike the prior art component design method which mandated often repeated calculations until the designer could ‘zero-in’ on the final assembly. The present method is an improvement on this prior method in that the selection of the necessary hardware and the calculation of the necessary bracing and spacing is now made very simple. The user need simply follow a flow chart and turn to the appropriate tables to find the necessary information.

While select preferred embodiments of this invention have been illustrated, many modifications may occur to those skilled in the art and therefore it is to be understood that these modifications are incorporated within these embodiments as fully as if they were fully illustrated and described herein.

What is claimed:

1. A method of selecting and positioning support components for a bracing system without calculating the forces in these components comprising;
choosing a design configuration of said bracing system,
determining the seismic coefficient of said design configuration,
ascertaining a load rating for said design configuration,
consulting one or more pre-engineered tables to select said support components, the spacing of said support components, and the anchor details and configuration of said support components.

2. The method as set forth in claim 1 wherein said support components provide bracing against seismic loading.

3. The method as set forth in claim 1 wherein said support components provide support along a length of a longitudinal member requiring such support.

4. A method of calculating seismic bracing products comprising the steps of:
(a) ascertaining the seismic coefficient to be employed for the structure to be assembled;
(b) selecting a design table for use, such design table being selected based on one or more of said seismic coefficient, assembly configuration and/or supporting material;
(c) using load rating to ascertain brace spacing data from said design table;
(d) being directed to suitable anchor detail dependent upon one or more of aforesaid seismic coefficient, assembly configuration, supporting material, load rating and/or brace spacing data.

5. The method of calculating seismic bracing products as set forth in claim 4 wherein the structure or structures to be assembled provides support to a single elongated member.

6. A method of calculating seismic bracing products comprising the steps of:
(a) Ascertaining the seismic coefficient to be employed for the structure to be assembled;
(b) selecting a design table for use, such design table being selected based on said seismic coefficient and one or more of said assembly configuration and supporting material;
(c) using load rating to ascertain brace spacing data from said design table;
(d) specifying suitable anchor detail dependent upon data from said design table.

7. The method of calculating seismic bracing products as set forth in claim 6 wherein the structure or structures to be assembled provides support to a single elongated member.

8. A method of calculating seismic bracing products of comprising the steps of:
(a) ascertaining the seismic coefficient to be employed for the structure to be assembled;
(b) ascertaining a load rating from the structure to be assembled;
(c) selecting a design table for use, such design table being selected based on one or more of said seismic coefficient, load rating, assembly configuration and/or supporting material;
(d) ascertaining brace spacing data from said design table;
(e) being directed to specific anchor detail dependent upon data from said design table.

9. The method of calculating seismic bracing products as set forth in claim 8 wherein the structure to be assembled provides support to one or more elongated members.
